(19) United States
(12) Patent Application Publication
(10) Pub. No.: US 2026/0030839 A1
(43) Pub. Date: Jan. 29, 2026

(54) INPUT EVENT DETECTION FOR EXTENDED REALITY (XR) HEADSETS BASED ON EYE TRACKING

(71) Applicant: Samsung Electronics Co., Ltd., Suwon-si (KR)

(72) Inventors: Christopher A. Peri, Mountain View, CA (US); Yingen Xiong, Mountain View, CA (US)

(21) Appl. No.: 19/060,477

(22) Filed: Feb. 21, 2025

Related U.S. Application Data
(60) Provisional application No. 63/674,661, filed on Jul. 23, 2024.

(51) Int. Cl. G06T 17/00; G02B 27/01; G06F 3/01; H04N 23/11

(52) U.S. Cl. CPC G06T 17/00; G02B 27/017; G06F 3/012; H04N 23/11; G02B 2027/0178

(57) ABSTRACT

A method includes capturing reflections of illumination from an eye of a user wearing an extended reality (XR) headset. The method also includes detecting movement of the XR headset based on changes in positions of the reflections of the illumination from the user's eye, where the movement changes a pose of the XR headset relative to the user's eye. The method further includes determining a direction based on the detected movement and causing content presented on at least one display of the XR headset to change based on the determined direction.

### CROSS-REFERENCE TO RELATED APPLICATION AND PRIORITY CLAIM

This application claims priority under 35 U.S.C. § 119(e) to U.S. Provisional Patent Application No. 63/674,661 filed on Jul. 23, 2024. This provisional patent application is hereby incorporated by reference in its entirety.

### TECHNICAL FIELD

This disclosure relates generally to extended reality (XR) systems and processes. More specifically, this disclosure relates to input event detection for extended reality (XR) headsets based on eye tracking.

### BACKGROUND

Extended reality (XR) systems are becoming more and more popular over time, and numerous applications have been and are being developed for XR systems. Some XR systems receive user input via handheld controllers, where users can hold the controllers in their hands and manipulate the controllers to provide different types of input. For example, users may move, rotate, shake, or perform other actions with the controllers in order to provide different types of inputs to the XR systems.

### SUMMARY

This disclosure relates to input event detection for extended reality (XR) headsets based on eye tracking.

In a first embodiment, a method includes capturing reflections of illumination from an eye of a user wearing an XR headset. The method also includes detecting movement of the XR headset based on changes in positions of the reflections of the illumination from the user's eye, where the movement changes a pose of the XR headset relative to the user's eye. The method further includes determining a direction based on the detected movement and causing content presented on at least one display of the XR headset to change based on the determined direction.

In a second embodiment, an XR headset configured to be worn on a user's head includes at least one display, at least one imaging sensor configured to capture reflections of illumination from an eye of the user, and at least one processing device. The at least one processing device is configured to detect movement of the XR headset based on changes in positions of the reflections of the illumination from the user's eye, where the movement changes a pose of the XR headset relative to the user's eye. The at least one processing device is also configured to determine a direction based on the detected movement and cause content presented on the at least one display to change based on the determined direction.

In a third embodiment, a non-transitory machine readable medium contains instructions that when executed cause at least one processor of an XR headset to detect movement of the XR headset based on changes in positions of reflections of illumination from an eye of a user, where the movement changes a pose of the XR headset relative to the user's eye. The non-transitory machine readable medium also contains instructions that when executed cause the at least one processor to determine a direction based on the detected movement and cause content presented on at least one display of the XR headset to change based on the determined direction.

Any one or any combination of the following features may be used with the first, second, or third embodiment. A magnitude of the movement may be determined, and the content presented on the at least one display of the XR headset may be caused to change based on the determined magnitude. The direction may be a scrolling direction that is one of up, down, forward, or backward, and the magnitude may be a scrolling speed. The movement of the XR headset may be detected by determining motion vectors associated with the changes in the positions of the reflections of the illumination from the user's eye. A magnitude may be determined based on the motion vectors, and the content presented on the at least one display of the XR headset may be caused to change based on the determined magnitude. The reflections of the illumination from the user's eye may be captured in a series of infrared images of the user's eye, and the movement of the XR headset may be detected based on the changes in the positions of the reflections captured in the series of infrared images. The movement of the XR headset may be detected using a machine learning model, and the machine learning model may be trained to output different directions and different magnitudes based on different changes in the positions of the reflections of the illumination from the user's eye.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates a portion of an example extended reality (XR) headset for illuminating a user's eye in accordance with this disclosure;

FIGS. 3A and 3B illustrate example reflections of illumination from a user's eye in accordance with this disclosure;

FIG. 4 illustrates example input events associated with an XR headset in accordance with this disclosure;

FIGS. 5A through 5D illustrate example input event detections by an XR headset based on eye tracking in accordance with this disclosure;

FIG. 6 illustrates an example architecture for input event detection for an XR headset based on eye tracking in accordance with this disclosure; and

FIG. 7 illustrates an example method for input event detection for an XR headset based on eye tracking in accordance with this disclosure.

### DETAILED DESCRIPTION

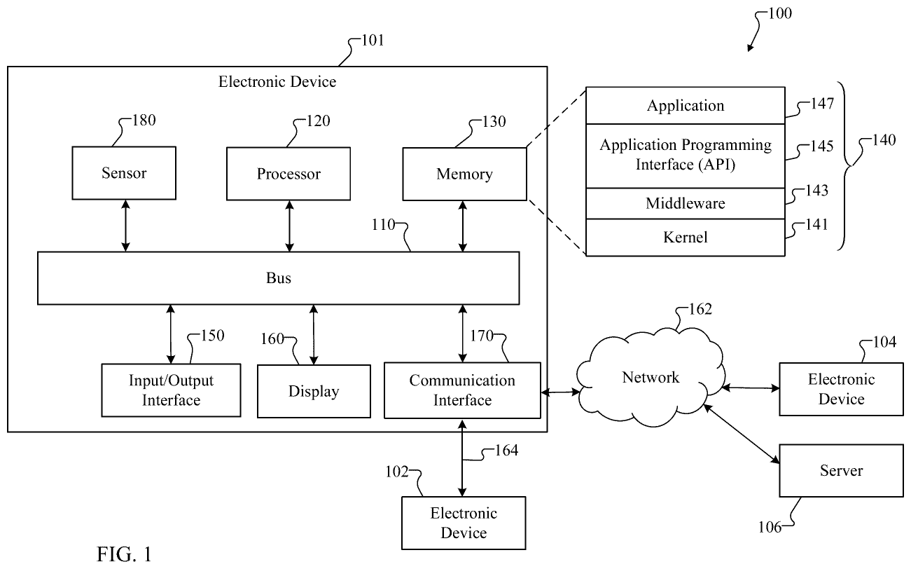

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems receive user input via handheld controllers, where users can hold the controllers in their hands and manipulate the controllers to provide different types of input. For example, users may move, rotate, shake, or perform other actions with the controllers in order to provide different types of inputs to the XR systems.

Various XR systems are currently moving to smaller and lighter form factors, and the use of dedicated handheld controllers may not be supported with some of these XR systems. Unfortunately, the lack of handheld controllers can complicate efforts to provide user input to the XR systems. For example, a web browsing app executed by an XR headset routinely needs user input regarding how content should be scrolled and displayed to a user. Moreover, some XR headsets are “lite” systems that lack significant processing resources or other resources. As a result, these XR headsets may be unable to use significant computing resources when identifying user input. Thus, for instance, while some XR headsets may capture images of users' hands and derive user input based on how the users move their hands within the captured images, lite or other XR headsets may be unable to perform significant image processing operations in order to identify user input.

This disclosure provides various techniques supporting input event detection for XR headsets based on eye tracking. As described in more detail below, reflections of illumination from an eye of a user wearing an XR headset can be captured. For example, the illumination may represent infrared illumination, and the reflections of the illumination may be captured in a series of infrared images. The reflections may represent reflections from the pupil and the cornea of the user's eye. Movement of the XR headset can be detected based on changes in positions of the reflections of the illumination from the user's eye. The movement can change a pose of the XR headset relative to the user's eye. A direction can be determined based on the detected movement, and content presented on at least one display of the XR headset can be caused to change based on the determined direction. Also, a magnitude of the movement can be determined, and the content presented on the at least one display of the XR headset can be caused to change based on the determined magnitude. In some cases, the direction can represent a scrolling direction that is one of up, down, forward, or backward, and the magnitude can represent a scrolling speed.

In this way, the disclosed techniques allow for user input to be identified based on how the user causes the XR headset to move relative to the user's eye(s). This can be accomplished without using physical touch sensors or other sensors that are physically contacted by the user. As a result, these techniques are suitable for use in a wide variety of XR headsets since these techniques do not rely on the presence of physical sensors to receive user input. Moreover, a direction and magnitude of movement of the XR headset caused by the user can be determined more quickly and easily compared to analyzing the user's hand motions in captured images. Because of this, these techniques can be performed using significantly less processing resources or other resources. In some cases, these techniques can be used in “lite” XR headsets or other resource-constrained XR headsets.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to input event detection based on eye tracking.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform input event detection based on eye tracking. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture images of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

The electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

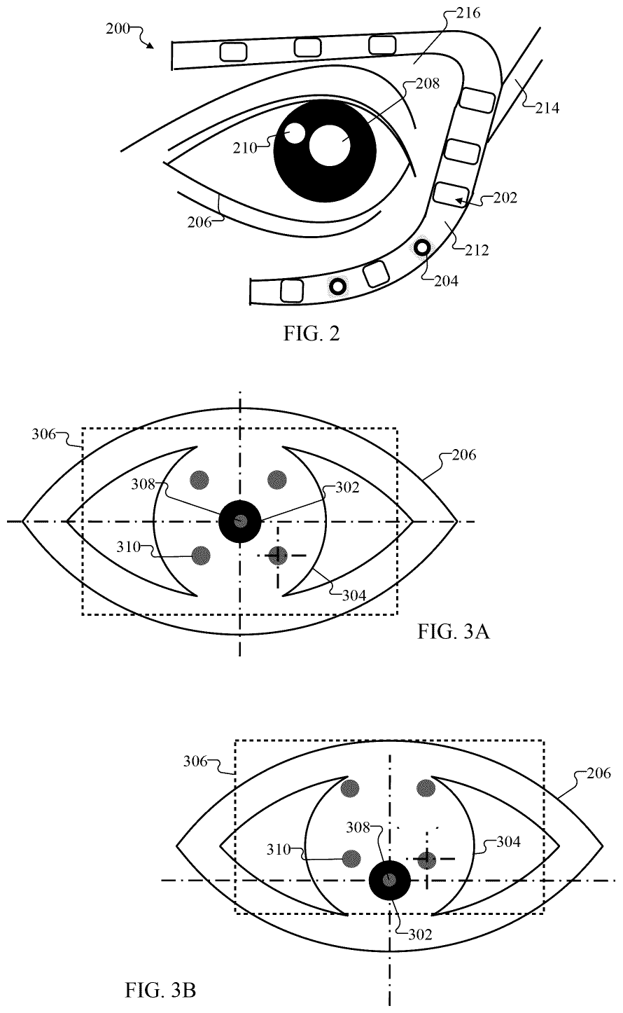

FIG. 2 illustrates a portion of an example XR headset 200 for illuminating a user's eye in accordance with this disclosure. The XR headset 200 may, for example, represent a specific implementation of the electronic device 101 in the network configuration 100 of FIG. 1. However, the XR headset 200 may be used in any other suitable system(s) and may be implemented in any other suitable manner. Also, while the XR headset 200 in this example takes the form of smart glasses, the XR headset 200 may have any other suitable form factor.

As shown in FIG. 2, the XR headset 200 includes one or more illumination sources 202 and one or more eye-tracking imaging sensors 204. Each illumination source 202 is configured to generate illumination that can be directed at a user's eye 206. Each illumination source 202 can generate any suitable illumination, such as infrared illumination. Note that the number and positions of the illumination sources 202 shown in FIG. 2 are for illustration only. The XR headset 200 may include any suitable number of illumination sources 202, and the illumination source(s) 202 may be positioned at any suitable location(s). Each illumination source 202 represents any suitable structure configured to generate illumination for a user's eye 206, such as an infrared or other light emitting diode (LED).

Each eye-tracking imaging sensor 204 is configured to capture one or more images of the user's eye 206. As described in more detail below, the illumination from the illumination source(s) 202 can reflect from the user's eye 206, and these reflections can be captured in the images obtained using the eye-tracking imaging sensor(s) 204. In some cases, for instance, the illumination from the illumination source(s) 202 can create a reflection 208 from the pupil of the user's eye 206 and one or more reflections 210 from the cornea of the user's eye 206. Each eye-tracking imaging sensor 204 can capture images of the user's eye 206 that include at least some of these reflections 208, 210. As described below, the locations of these reflections 208, 210 can be used by the XR headset 200 to identify user input. Each eye-tracking imaging sensor 204 includes any suitable structure configured to capture images of a user's eye 206, such as an infrared or other camera.

Note that eye-tracking technology often attempts to identify the deformation of reflections off a user's eye in order to measure eye movements. However, in the techniques described below, the positions of illumination reflections can be used to sense movement of the XR headset 200 relative to the user's eye 206. This movement can be created when the user moves the XR headset 200, such as when the user makes a swiping motion on the XR headset 200 (like on a rim 212 or arm 214 of the frame of the XR headset 200) or when the user grabs part of the XR headset 200 and moves the XR headset 200 relative to the user's eye 206. Each rim 212 of the XR headset 200 represents a portion of the XR headset 200 that can hold a window or lens 216 of the XR headset 200. Different movements of the XR headset 200 can create different displacements or pose changes of the XR headset 200 relative to the user's eye 206, and these different pose changes can be identified and used to represent different user inputs. For instance, the direction of the movement may indicate a desired scrolling direction, and the magnitude of the movement may indicate a desired scrolling magnitude. By measuring one or more characteristics of the movement of the XR headset 200 relative to the user's eye 206, the XR headset 200 is able to identify the type of user input being provided, and the XR headset 200 can take one or more actions in response to the identified user input.

Although FIG. 2 illustrates a portion of one example of an XR headset 200 for illuminating a user's eye 206, various changes may be made to FIG. 2. For example, the XR headset 200 may have any other suitable form factor. Also, the arrangement shown in FIG. 2 can be duplicated on the opposite side of the XR headset 200, meaning each eye 206 of the user may be illuminated using one or more illumination sources 202 and imaged using one or more eye-tracking imaging sensors 204.

FIGS. 3A and 3B illustrate example reflections of illumination from a user's eye 206 in accordance with this disclosure. For ease of explanation, the reflections of FIGS. 3A and 3B are described as being created by the XR headset 200 of FIG. 2, which may be implemented using the electronic device 101 in the network configuration 100 of FIG. 1. However, the reflections of FIGS. 3A and 3B may be created using any other suitable device(s) and in any other suitable system(s).

As shown in FIGS. 3A and 3B, the user's eye 206 includes a pupil 302 and a cornea 304. Also shown here is an eye box 306, which represents a portion of the user's eye 206 that might be imaged using at least one eye-tracking imaging sensor 204. When the user's eye 206 is illuminated (such as by one or more illumination sources 202), the pupil 302 of the user's eye 206 creates a reflection 308, which can be the same as the reflection 208 and which is often very bright. In addition, the cornea 304 of the user's eye 206 often creates one or more reflections 310, each of which can be the same as the reflection 210. The reflections are sometimes referred to as “glints.”

As can be seen in FIG. 3A, the eye box 306 is generally centered on the middle of the user's eye 206. This may represent a normal position of the XR headset 200 relative to the user's eye 206, such as the position that is achieved when the user is wearing the XR headset 200 normally without interaction. As can be seen in FIG. 3B, the eye box 306 has been moved upward and is now generally centered on an upper portion of the user's eye 206. This may represent a position of the XR headset 200 created when the user makes a swiping motion upward on the XR headset 200 or otherwise moves the XR headset 200 upward relative to the user's eye 206. As can be seen here, the position of the reflection 308 from the user's pupil 302 and the positions of the reflections 310 from the user's cornea 304 have changed within the eye box 306. The positions of the reflections 310 from the user's cornea 304 have also changed relative to the position of the reflection 308 from the user's pupil 302.

Based on these position changes, it is possible for the XR headset 200 to identify how the XR headset 200 is moved relative to one or both of the user's eyes 206. For example, the direction of the movement of the XR headset 200 relative to the user's eye(s) 206 can be determined based on the direction of the movement of the reflections 308, 310 from the normal position of the XR headset 200. Also, the magnitude of the movement of the XR headset 200 relative to the user's eye(s) 206 can be determined based on the amount of movement of the reflections 308, 310 from the normal position of the XR headset 200.

Note that the XR headset 200 here does not need to include any physical sensors that are contacted by the user when creating movement of the XR headset 200 relative to the user's eye(s) 206. For example, the user need not physically contact one or more sensors on the rim 212 or arm 214 of the XR headset 200 in order to make a pose change that is sensed by the XR headset 200. Instead, the XR headset 200 can determine one or more characteristics of the pose change based on how the reflections 308, 310 from the user's eye(s) 206 change as a result of the movement of the XR headset 200 relative to the user's eye(s) 206.

Although FIGS. 3A and 3B illustrate one example of reflections of illumination from a user's eye 206, various changes may be made to FIGS. 3A and 3B. For example, as described below, movement of the XR headset 200 relative to the user's eye(s) 206 may occur in different directions, which may be indicative of different types of user inputs to the XR headset 200. Also, there may be any suitable number of reflections 310 from the user's cornea 304 that may be used to sense movement of the XR headset 200 relative to the user's eye(s) 206.

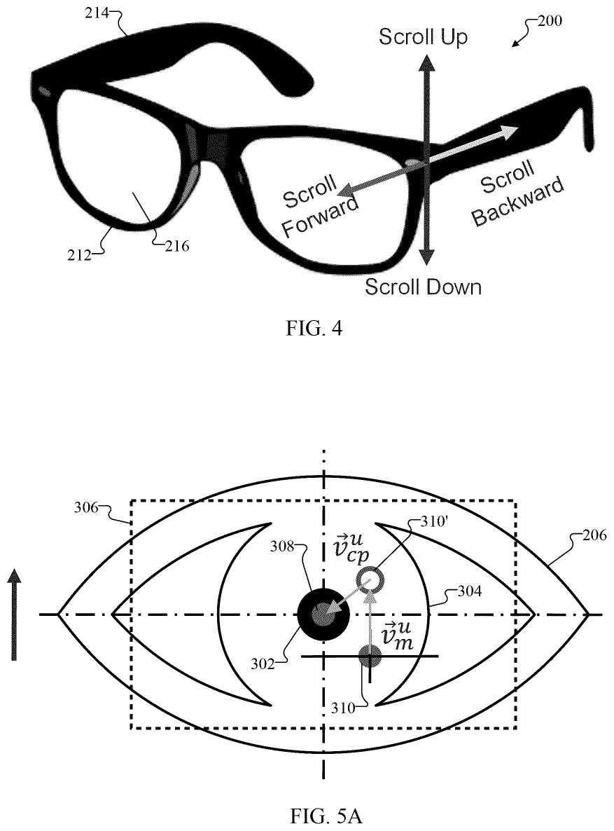

FIG. 4 illustrates example input events associated with an XR headset 200 in accordance with this disclosure. For ease of explanation, the input events of FIG. 4 are described as being sensed by the XR headset 200 of FIG. 2 based on the types of reflections 308, 310 shown in FIGS. 3A and 3B, where the XR headset 200 may be implemented using the electronic device 101 in the network configuration 100 of FIG. 1. However, the input events of FIG. 4 may be sensed using any other suitable device(s) and in any other suitable system(s).

As described above, a user can make various swiping motions on the XR headset 200 or otherwise cause movement of the XR headset 200 relative to the user's eye(s) 206. Different movements of the XR headset 200 can be used to represent different types of inputs to the XR headset 200. In some embodiments, the movements can be associated with different scrolling commands. For example, the XR headset 200 may be used to present content to a user by displaying the content on the windows or lenses 216 of the XR headset 200. As a particular example, the XR headset 200 may execute a web browsing app or other app that allows the user to view web pages or other content.

In order to support scrolling of the content presented to the user by the XR headset 200, the XR headset 200 can be configured to recognize different types of user inputs based on different movements of the XR headset 200 relative to the user's eye(s) 206. In this example, the user may create a movement indicative of a “scroll up” command by causing upward movement of the XR headset 200 relative to the user's eye(s) 206, and the user may create a movement indicative of a “scroll down” command by causing downward movement of the XR headset 200 relative to the user's eye(s) 206. Also, the user may create a movement indicative of a “scroll forward” command by causing forward movement of the XR headset 200 relative to the user's eye(s) 206, and the user may create a movement indicative of a “scroll back” command by causing backward movement of the XR headset 200 relative to the user's eye(s) 206.

As described below, when the user moves the XR headset 200 relative to the user's eye(s) 206, the locations of the illumination source(s) 202 can change relative to the user's eye(s) 206. This changes how at least one of the user's eyes 206, such as the user's pupil 302 and cornea 304 in the user's eye(s) 206, reflect the illumination from the illumination source(s) 202. Thus, different types of movements of the XR headset 200 can cause different changes to the reflections 308, 310 created by the user's eye(s) 206. By sensing the direction(s) of the changes to the positions of the reflections 308, 310, the XR headset 200 is able to determine which scrolling command is being input by the user. Also, different magnitudes of movements of the XR headset 200 relative to the user's eye(s) 206 can cause different magnitudes of changes to the positions of the reflections 308, 310 created by the user's eye(s) 206. By sensing the magnitude of the changes to the positions of the reflections 308, 310, the XR headset 200 is able to determine the magnitude of the scrolling command that is being input by the user. Here, the magnitude of a scrolling command can be used to control the speed of scrolling.

In some embodiments, the XR headset 200 can process a series of images capturing one or more of the user's eyes 206, and the XR headset 200 can identify the direction and magnitude of the movement of the XR headset 200 relative to the user's eye(s) 206 based on the series of images. For instance, the XR headset 200 may determine one or more motion vectors based on the changes to the positions of the reflections 308, 310 from the user's eye(s) 206. As a particular example, the XR headset 200 may identify one or more motion vectors each indicating motion of a reflection 310 from the user's cornea 304 between images in the series, and the XR headset 200 may identify one or more motion vectors each indicating motion between a reflection 308 from the user's pupil 302 and a reflection 310 from the user's cornea 304. By analyzing these motion vectors, the direction and magnitude of the movement of the XR headset 200 relative to the user's eye(s) 206 can be determined.

Although FIG. 4 illustrates one example of input events associated with an XR headset 200, various changes may be made to FIG. 4. For example, the input events that are detected by the XR headset 200 may or may not relate to scrolling command inputs. The four input events shown here are examples only, and other or additional input events may be detected by the XR headset 200.

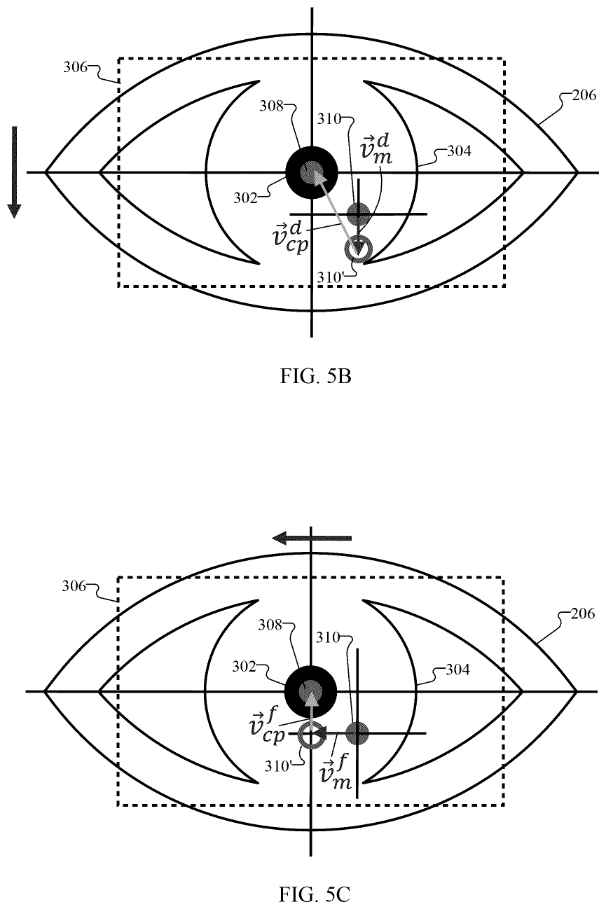

FIGS. 5A through 5D illustrate example input event detections by an XR headset 200 based on eye tracking in accordance with this disclosure. More specifically, FIGS. 5A through 5D illustrate how the four example input events shown in FIG. 4 may be detected by the XR headset 200. Note that these input event detections are examples only and that other input event detections may be performed by the XR headset 200.

In the following examples, two motion vectors are defined for each movement of the XR headset 200 relative to the user's eye 206. One motion vector

$$( denoted {\vec{v}}_{m}^{x} )$$

represents motion of a reflection 310 from the user's cornea 304, meaning this motion vector identifies a change in the location of a reflection 310 from the user's cornea 304 between different images captured at different times. Another motion vector

$$( denoted {\vec{v}}_{c p}^{x} )$$

represents motion between the reflection 310 from the user's cornea 304 and a reflection 308 from the user's pupil 302, meaning this motion vector identifies the difference in positions of the two reflections 308, 310. The value x in the above notations can be replaced with u for upward movement of the XR headset 200, d for downward movement of the XR headset 200, f for forward movement of the XR headset 200, and b for backward movement of the XR headset 200.

As shown in FIG. 5A, the user has moved the XR headset 200 upward relative to the user's eye 206. Here, a reflection 310 represents a reflection from the user's cornea 304 prior to this movement, and a reflection 310′ represents a reflection from the user's cornea 304 after this movement. The differences in the locations of the reflections 310 and 310′ form a motion vector

$${\vec{v}}_{m}^{u} .$$

Also, the differences in the locations of the reflections 310′ and 308 form a motion vector

$${\vec{v}}_{c p}^{u} .$$

The XR headset 200 can use the upward direction of the motion vector

$${\vec{v}}_{m}^{u}$$

and the inward and downward direction of the motion vector

$${\vec{v}}_{c p}^{u}$$

to identify that the XR headset 200 has been moved upward relative to the user's eye 206. The XR headset 200 can also use the magnitude(s) of one or both motion vectors to identify the magnitude of the upward movement of the XR headset 200 relative to the user's eye 206. Note, however, that the reflections 310 and 310′ may alternatively be positioned to the left of the user's pupil 302.

As shown in FIG. 5B, the user has moved the XR headset 200 downward relative to the user's eye 206. Here, a reflection 310 represents a reflection from the user's cornea 304 prior to this movement, and a reflection 310′ represents a reflection from the user's cornea 304 after this movement. The differences in the locations of the reflections 310 and 310′ form a motion vector

$${\vec{v}}_{m}^{d} .$$

Also, the differences in the locations of the reflections 310′ and 308 form a motion vector

$${\vec{v}}_{c p}^{d} .$$

The XR headset 200 can use the downward direction of the motion vector

$${\vec{v}}_{m}^{d}$$

and the inward and upward direction of the motion vector

$${\vec{v}}_{c p}^{d}$$

to identify that the XR headset 200 has been moved downward relative to the user's eye 206. The XR headset 200 can also use the magnitude(s) of one or both motion vectors to identify the magnitude of the downward movement of the XR headset 200 relative to the user's eye 206. Note, however, that the reflections 310 and 310′ may alternatively be positioned to the left of the user's pupil 302.

As shown in FIG. 5C, the user has moved the XR headset 200 forward relative to the user's eye 206. Here, a reflection 310 represents a reflection from the user's cornea 304 prior to this movement, and a reflection 310′ represents a reflection from the user's cornea 304 after this movement. The differences in the locations of the reflections 310 and 310′ form a motion vector

$${\vec{v}}_{m}^{f} .$$

Also, the differences in the locations of the reflections 310′ and 308 form a motion vector

$${\vec{v}}_{c p}^{f} .$$

The XR headset 200 can use the inward direction of the motion vector

$${\vec{v}}_{m}^{f}$$

and the upward direction of the motion vector

$${\vec{v}}_{c p}^{f}$$

to identify that the XR headset 200 has been moved forward relative to the user's eye 206. The XR headset 200 can also use the magnitude(s) of one or both motion vectors to identify the magnitude of the forward movement of the XR headset 200 relative to the user's eye 206. Note, however, that the reflection 310 may alternatively be positioned to the left of the user's pupil 302.

As shown in FIG. 5D, the user has moved the XR headset 200 backward relative to the user's eye 206. Here, a reflection 310 represents a reflection from the user's cornea 304 prior to this movement, and a reflection 310′ represents a reflection from the user's cornea 304 after this movement. The differences in the locations of the reflections 310 and 310′ form a motion vector

$${\vec{v}}_{m}^{b} .$$

Also, the differences in the locations of the reflections 310′ and 308 form a motion vector

$${\vec{v}}_{c p}^{b} .$$

The XR headset 200 can use the outward direction of the motion vector

$${\vec{v}}_{m}^{b}$$

and the upward and inward direction of the motion vector

$${\vec{v}}_{c p}^{b}$$

to identify that the XR headset 200 has been moved backward relative to the user's eye 206. The XR headset 200 can also use the magnitude(s) of one or both motion vectors to identify the magnitude of the backward movement of the XR headset 200 relative to the user's eye 206. Note, however, that the reflection 310′ may alternatively be positioned to the left of the user's pupil 302.

In the above description, the terms “inward” and “outward” are used to refer to directions relative to the pupil 302 of the user's eye 206. That is, “inward” refers to a motion vector that points towards the pupil 302 of the user's eye or otherwise towards a vertical axis on which the pupil 302 of the user's eye lies. Conversely, “outward” refers to a motion vector that points away from the pupil 302 of the user's eye or otherwise away from the vertical axis on which the pupil 302 of the user's eye lies. This notation is used since various reflections 310, 310′ may occur on either side of the user's pupil 302, such as depending on whether it is the user's left or right eye 206 being illuminated and imaged.

Although FIGS. 5A through 5D illustrate examples of input event detections by an XR headset 200 based on eye tracking, various changes may be made to FIGS. 5A through 5D. For example, the specific movements of the XR headset 200 shown here are examples only and can vary as needed or desired.

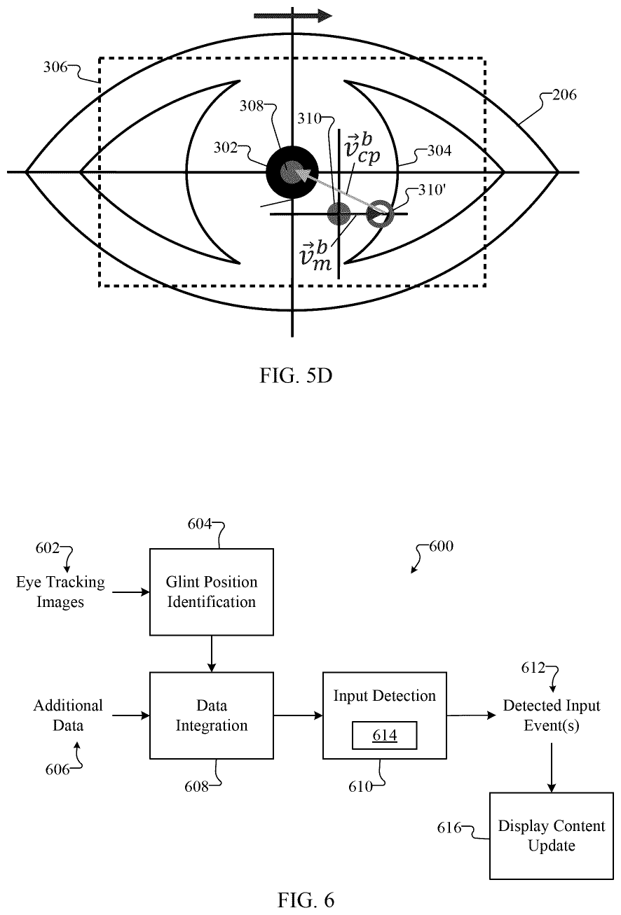

FIG. 6 illustrates an example architecture 600 for input event detection for an XR headset based on eye tracking in accordance with this disclosure. For ease of explanation, the architecture 600 of FIG. 6 is described as being implemented within the XR headset 200 of FIG. 2, which may be implemented using the electronic device 101 in the network configuration 100 of FIG. 1. However, the architecture 600 may be implemented using any other suitable device(s) and in any other suitable system(s).

As shown in FIG. 6, the architecture 600 generally operates to receive and process eye tracking images 602. The eye tracking images 602 represent images of one or more eyes 206 of a user, such as images captured by one or more eye-tracking imaging sensors 204. Each eye tracking image 602 can have any suitable size, shape, and resolution and include image data in any suitable domain. As particular examples, each eye tracking image 602 may include RGB image data, YUV image data, or Bayer or other raw image data. The architecture 600 can receive and process any suitable number of eye tracking images 602, such as one or more streams of eye tracking images 602.

The eye tracking images 602 are provided to a glint position identification function 604, which generally operates to identify the position of reflections 308, 310, 310′ from the user's eye(s) 206 as captured in the eye tracking images 602. For example, the glint position identification function 604 can identify the position of a reflection 308 from at least one pupil 302 of at least one of the user's eyes 206 and one or more reflections 310, 310′ from at least one cornea 304 of at least one of the user's eyes 206. In some embodiments, the glint position identification function 604 may operate based on image intensities and identify the area(s) of each eye tracking image 602 having the brightest intensity or intensities. In some cases, for instance, the glint position identification function 604 may identify the boundary of the user's pupil 302 and cornea 304 in each eye tracking image 602 and identify the location(s) within each structure having the brightest intensity or intensities.

The architecture 600 may also optionally receive one or more other forms of additional data 606. The additional data 606 may represent information that might be useful in identifying the pose of the XR headset 200 relative to the user's eye(s) 206. For example, in some embodiments, the additional data 606 may include orientation data, such as data from one or more IMUs. As a particular example, the XR headset 200 may include one or more IMUs located at one or more locations of the XR headset 200, such as in one or more rims 212 and/or one or more arms 214. The IMU(s) can be used to provide three-dimensional orientation data regarding the orientation of at least part of the XR headset 200. This may be useful, for instance, for identifying when and how the XR headset 200 has been moved by the user. If any additional data 606 is made available for use, a data integration function 608 can be used to combine the additional data 606 with the identified glint locations. For example, the data integration function 608 can combine the identified glint locations for each eye-tracking imaging sensor 204 with orientation data identifying an orientation or orientation change associated with that eye-tracking imaging sensor 204. If additional data 606 is not made available for use, the data integration function 608 may be omitted.

An input detection function 610 generally operates to process the identified glint locations and optionally additional data 606 in order to detect when the user provides one or more inputs to the XR headset 200 by moving the XR headset 200 relative to the user's eye(s) 206. For example, the input detection function 610 may analyze the identified glint locations as identified in multiple eye tracking images 602 over time in order to detect changes in the positions of the reflections from the user's eye(s) 206. As noted above, for instance, the input detection function 610 may calculate motion vectors

$${\vec{v}}_{m}^{x}$$

and motion vectors

$${\vec{v}}_{c p}^{x}$$

based on the reflections 308, 310, 310′ detected in the eye tracking images 602. The input detection function 610 can also analyze the motion vectors to determine whether the motion vectors are indicative of a pose change between the XR headset 200 and the user's eye(s) 206 (such as its direction and magnitude). The input detection function 610 here can output one or more detected input events 612, which represent or are associated with one or more inputs provided by the user via one or more movements of the XR headset 200. For instance, each detected input event 612 may include a direction of movement or a command associated with the direction of movement, optionally along with a magnitude of the movement or a magnitude of the command associated with the direction of movement.

In some embodiments, the input detection function 610 may use at least one machine learning model 614 to identify a pose change between the XR headset 200 and the user's eye(s) 206 and/or a detected input event 612 associated with such a pose change. For example, the machine learning model 614 can be trained to process eye tracking images 602 or detected glint positions (and optionally additional data 606) and identify detected directions and detected magnitudes of movement between the XR headset 200 and the user's eye(s) 206. This allows the machine learning model 614 to be trained to identify pose changes based on changes in the positions of the reflections of illumination from the user's eye(s) 206. The machine learning model 614 can also be trained to identify different detected input events 612 that are associated with different detected directions and detected magnitudes of movement. For instance, the machine learning model 614 can be trained to identify different scrolling commands or other commands based on the detected movement of the XR headset 200 relative to the user's eye(s) 206, and the machine learning model 614 can be trained to identify different scrolling magnitudes or other magnitudes based on the detected movement of the XR headset 200 relative to the user's eye(s) 206.

The machine learning model 614 can use any suitable machine learning architecture and can be trained in any suitable manner. For example, during training, the machine learning model 614 can process training eye tracking images or training glint positions (and optionally additional information), and weights or other parameters of the machine learning model 614 can be adjusted until the machine learning model 614 accurately generates detected directions/magnitudes and/or detected input events 612 (at least to within a desired threshold of accuracy).

Each detected input event 612 may have any suitable form. In some embodiments, each detected input event 612 may include an event identifier and an event value. In some cases, the event identifier may uniquely identify each detected input event, and the corresponding event value may represent a type of input event detected. As a particular example, the event value may indicate whether the associated detected input event 612 is a scroll up, scroll down, scroll forward, or scroll backward event.

The detected input events 612 may be used in any suitable manner. In some embodiments, the detected input events 612 may be provided to an operating system (OS) of the XR headset 200. As a particular example, each detected input event 612 may be provided as a human interface device (HID) event. In this example, the detected input events 612 are provided to a display content update function 616, which can use the detected input events 612 to determine how to update or change the content being displayed to the user by the XR headset 200. For instance, the display content update function 616 may cause a web browsing app or other app executed by the XR headset 200 to scroll up, scroll down, scroll forward, or scroll backward, which can change the content being displayed to the user by the XR headset 200.

Although FIG. 6 illustrates one example of an architecture 600 for input event detection for an XR headset based on eye tracking, various changes may be made to FIG. 6. For example, various components or functions in FIG. 6 may be combined, further subdivided, replicated, omitted, or rearranged and additional components or functions may be added according to particular needs.

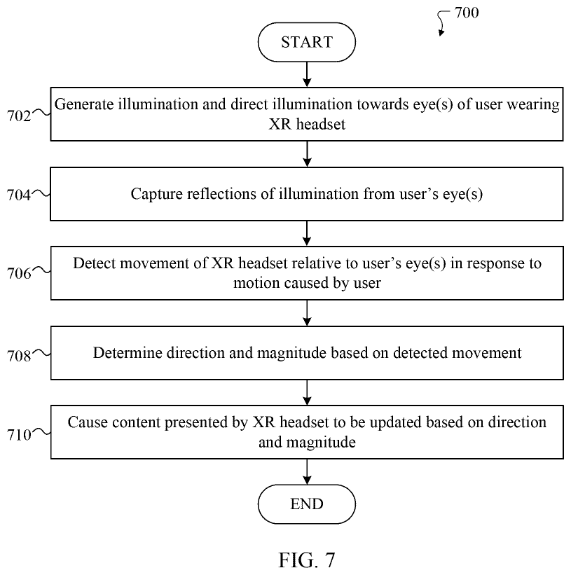

FIG. 7 illustrates an example method 700 for input event detection for an XR headset based on eye tracking in accordance with this disclosure. For ease of explanation, the method 700 of FIG. 7 is described as being performed within the XR headset 200 of FIG. 2, which may be implemented using the electronic device 101 in the network configuration 100 of FIG. 1 and which may implement the architecture 600 of FIG. 6. However, the method 700 may be performed using any other suitable device(s) and architecture(s) and in any other suitable system(s).

As shown in FIG. 7, illumination is generated and directed towards at least one eye of a user wearing an XR headset at step 702. This may include, for example, the one or more illumination source(s) 202 generating infrared or other illumination and directing the illumination at the user's eye(s) 206. Reflections of the illumination from the user's eye(s) are captured at step 704. This may include, for example, the one or more eye-tracking imaging sensors 204 capturing eye tracking images 602 of the user's eye(s) 206. In some cases, the one or more eye-tracking imaging sensors 204 may capture a series of images, such as a series of infrared images.

Movement of the XR headset relative to the user's eye(s) is detected at step 706, and a direction and optionally a magnitude associated with the movement are identified at step 708. The movement here can be caused by the user and can change a pose of the XR headset 200 relative to the user's eye(s) 206. This may include, for example, the processor 120 of the XR headset 200 performing the glint position identification function 604 to detect reflections 308, 310, 310′ captured in the eye tracking images 602 and performing the input detection function 610 to identify changes in the positions of the detected reflections 308, 310, 310′ over time. This may also include the processor 120 of the XR headset 200 performing the input detection function 610 to identify one or more detected input events 612 based on the detected movement of the XR headset 200 relative to the user's eye(s) 206. As a particular example, the XR headset 200 may identify the motion vectors associated with the changes in the positions of the reflections of the illumination from the user's eye(s) 206 as described above, and the XR headset 200 can use the motion vectors to identify the direction and optionally the magnitude associated with the movement. In some cases, the input detection function 610 can use a machine learning model that has been trained to identify the direction and magnitude of the movement and/or the user input command associated with the direction and magnitude of the movement. In some embodiments, the XR headset 200 can identify the direction as a scrolling direction that is up, down, forward, or backward, and the XR headset 200 can identify the magnitude as a scrolling speed.

Content presented on at least one display of the XR headset is change based on the determined direction and optionally the determined magnitude at step 710. This may include, for example, the processor 120 of the XR headset 200 performing the display content update function 616, which may cause the XR headset 200 to scroll up, scroll down, scroll forward, or scroll backward depending on the direction of the movement of the XR headset 200 and to scroll at a speed based on the magnitude of the movement of the XR headset 200. Note, however, that detected inputs events may involve any other suitable action(s) by the XR headset 200.

Although FIG. 7 illustrates one example of a method 700 for input event detection for an XR headset based on eye tracking, various changes may be made to FIG. 7. For example, while shown as a series of steps, various steps in FIG. 7 may overlap, occur in parallel, occur in a different order, or occur any number of times (including zero times). Also, the method 700 may involve detecting XR headset movement relative to one of the user's eyes 206 or both of the user's eyes 206.

It should be noted that the functions shown in the figures or described above can be implemented in an electronic device 101, 102, 104 or other device(s) in any suitable manner. For example, in some embodiments, at least some of the functions shown in the figures or described above can be implemented or supported using one or more software applications or other software instructions that are executed by the processor 120 of the electronic device 101, 102, 104 or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
capturing reflections of illumination from an eye of a user wearing an extended reality (XR) headset;
detecting movement of the XR headset based on changes in positions of the reflections of the illumination from the user's eye, wherein the movement changes a pose of the XR headset relative to the user's eye;
determining a direction based on the detected movement; and
causing content presented on at least one display of the XR headset to change based on the determined direction.

2. The method of claim 1, further comprising:
determining a magnitude of the movement; and
causing the content presented on the at least one display of the XR headset to change based on the determined magnitude.

3. The method of claim 2, wherein:
the direction is a scrolling direction that is one of up, down, forward, or backward; and
the magnitude is a scrolling speed.

4. The method of claim 1, wherein detecting the movement of the XR headset comprises determining motion vectors associated with the changes in the positions of the reflections of the illumination from the user's eye.

5. The method of claim 4, further comprising:
determining a magnitude based on the motion vectors; and
causing the content presented on the at least one display of the XR headset to change based on the determined magnitude.

6. The method of claim 1, wherein:
capturing the reflections of the illumination from the user's eye comprises directing infrared illumination towards the user's eye from the XR headset and capturing a series of infrared images of the user's eye using one or more imaging sensors of the XR headset; and
detecting the movement of the XR headset comprises detecting the movement of the XR headset based on the changes in the positions of the reflections captured in the series of infrared images.

7. The method of claim 1, wherein:
detecting the movement of the XR headset comprises detecting the movement of the XR headset using a machine learning model; and
the machine learning model is trained to output different directions and different magnitudes based on different changes in the positions of the reflections of the illumination from the user's eye.

8. An extended reality (XR) headset configured to be worn on a user's head, the XR headset comprising:
at least one display;
at least one imaging sensor configured to capture reflections of illumination from an eye of the user; and
at least one processing device configured to:
detect movement of the XR headset based on changes in positions of the reflections of the illumination from the user's eye, wherein the movement changes a pose of the XR headset relative to the user's eye;
determine a direction based on the detected movement; and
cause content presented on the at least one display to change based on the determined direction.

9. The XR headset of claim 8, wherein the at least one processing device is further configured to:
determine a magnitude of the movement; and
cause the content presented on the at least one display of the XR headset to change based on the determined magnitude.

10. The XR headset of claim 9, wherein:
the direction is a scrolling direction that is one of up, down, forward, or backward; and
the magnitude is a scrolling speed.

11. The XR headset of claim 8, wherein, to detect the movement of the XR headset, the at least one processing device is configured to determine motion vectors associated with the changes in the positions of the reflections of the illumination from the user's eye.

12. The XR headset of claim 11, wherein the at least one processing device is further configured to:
determine a magnitude based on the motion vectors; and
cause the content presented on the at least one display of the XR headset to change based on the determined magnitude.

13. The XR headset of claim 8, wherein:
the XR headset further comprises one or more infrared light sources configured to direct infrared illumination towards the user's eye;
the at least one imaging sensor is configured to capture a series of infrared images of the user's eye; and
the at least one processing device is configured to detect the movement of the XR headset based on the changes in the positions of the reflections captured in the series of infrared images.

14. The XR headset of claim 8, wherein:
the at least one processing device is configured to detect the movement of the XR headset using a machine learning model; and
the machine learning model is trained to output different directions and different magnitudes based on different changes in the positions of the reflections of the illumination from the user's eye.

15. A non-transitory machine readable medium containing instructions that when executed cause at least one processor of an extended reality (XR) headset to:
detect movement of the XR headset based on changes in positions of reflections of illumination from an eye of a user, wherein the movement changes a pose of the XR headset relative to the user's eye;
determine a direction based on the detected movement; and
cause content presented on at least one display of the XR headset to change based on the determined direction.

16. The non-transitory machine readable medium of claim 15, further containing instructions that when executed cause the at least one processor to:
determine a magnitude of the movement; and
cause the content presented on the at least one display of the XR headset to change based on the determined magnitude.

17. The non-transitory machine readable medium of claim 16, wherein:
the direction is a scrolling direction that is one of up, down, forward, or backward; and
the magnitude is a scrolling speed.

18. The non-transitory machine readable medium of claim 15, wherein the instructions that when executed cause the at least one processor to detect the movement of the XR headset comprise:
instructions that when executed cause the at least one processor to determine motion vectors associated with the changes in the positions of the reflections of the illumination from the user's eye.

19. The non-transitory machine readable medium of claim 18, further containing instructions that when executed cause the at least one processor to:
determine a magnitude based on the motion vectors; and
cause the content presented on the at least one display of the XR headset to change based on the determined magnitude.

20. The non-transitory machine readable medium of claim 15, wherein:
the instructions when executed cause the at least one processor to detect the movement of the XR headset using a machine learning model; and
the machine learning model is trained to output different directions and different magnitudes based on different changes in the positions of the reflections of the illumination from the user's eye.
